(19) United States
(12) Patent Application Publication
(10) Pub. No.: US 2025/0045577 A1
(43) Pub. Date: Feb. 6, 2025

(54) STOCHASTIC OPTIMIZATION USING MACHINE LEARNING

(71) Applicant: Google LLC, Mountain View, CA (US)

(72) Inventors: Bo Dai, San Jose, CA (US); Hanjun Dai, Atlanta, GA (US); Yuan Xue, Palo Alto, CA (US); Zia Syed, Los Altos, CA (US); Dale Eric Schuurmans, Edmonton (CA)

(21) Appl. No.: 18/697,304

(22) PCT Filed: Oct. 5, 2021
(86) PCT No.: PCT/US2021/053569

§ 371 Date: Mar. 29, 2024

(51) Int. Cl. G06N 3/08

(52) U.S. Cl. CPC G06N 3/08

(57) ABSTRACT

Methods, systems, and apparatus, including computer programs encoded on computer storage media, for performing stochastic optimization using machine learning. One of the methods includes obtaining data defining a multi-stage stochastic optimization (MSSO) problem instance, the data characterizing an observation distribution, an action space, and a cost function; generating a neural network input characterizing the MSSO problem instance from the data; providing the neural network input as input to a neural network that generates, from the network input, a neural network output characterizing parameters of a value function corresponding to the MSSO problem instance; processing the neural network input using the neural network to generate the neural network output; obtaining a new observation determined according to the observation distribution for the MSSO problem instance; determining, using the value function characterized by the network output, an optimal action to take in response to the new observation; and executing the optimal action.

### BACKGROUND

This specification relates to neural networks. Neural networks are machine learning models that employ one or more layers of nonlinear units to predict an output for a received input. Some neural networks include one or more hidden layers in addition to an output layer. The output of each hidden layer is used as input to one or more other layers in the network, i.e., one or more other hidden layers, the output layer, or both. Each layer of the network generates an output from a received input in accordance with current values of a respective set of parameters.

This specification also relates to stochastic optimization. Stochastic optimization refers to techniques for minimizing or maximizing an objective function under stochastic conditions, e.g., when constraints of the objective function are stochastic or when the objective function is itself stochastic. Stochastic optimization problems are often modeled as an agent executing an action to interact with an environment and receiving a reward (or penalty) in response to the action. Multi-stage stochastic optimization refers to minimizing or maximizing an objective function under stochastic conditions across multiple stages, e.g., by maximizing the total rewards across the stages or the final reward for the final stage. For example, across multiple time steps in an environment, an agent can iteratively execute an action, receive feedback from the environment, and use the feedback to select the next action for the next time step.

In this specification, a stochastic optimization problem defines a set of parameters that, when instantiated with respective parameter values, describe a stochastic environment and an objective function to be maximized or minimized by interacting with the stochastic environment. An “instance” of a stochastic optimization problem identifies a respective parameter value for each parameter defined by the stochastic optimization problem: that is, the stochastic optimization problem instance is a particular instantiation of the stochastic optimization problem.

### SUMMARY

This specification describes a system implemented as computer programs on one or more computers in one or more locations that uses a neural network to generate parameters for a stochastic optimizer to solve a multi-stage stochastic optimization problem instance. The neural network can be configured through training to approximate a value function that identifies, for a particular action at a particular time step of the multi-stage stochastic optimization problem instance, an expected value of future costs or rewards if the particular action were executed at the particular time point. A system can thus use the value function generated by the neural network to select actions to interact with the environment according to the multi-stage stochastic optimization problem instance.

The subject matter described in this specification can be implemented in particular embodiments so as to realize one or more of the following advantages.

Some existing techniques for solving multi-stage stochastic optimization problem instances are iterative techniques that require a system to execute hundreds or thousands of iterations to generate an approximated value function for the problem instance. Such techniques can have a significant time and computational cost. Using techniques described in this specification, a system can use a trained neural network to generate a value function using significantly less time and computational resources. For example, in some implementations described in this specification, the neural network can generate parameters for the value function in a single forward pass.

Using some existing techniques, a system must compute a solution from scratch for each problem instance of the same stochastic optimization problem. That is, the existing techniques are unable to leverage the similarity between the different problem instances of the same stochastic optimization problem to improve efficiency. Using techniques described in this specification, a system can train a neural network to generate value functions for any problem instance of a particular stochastic optimization problem in an efficient manner. The system can train the neural network using samples of many different instances of the stochastic optimization problem, allowing the neural network to learn patterns between the problem instances and thus leverage their common parameterization for further improved efficiency.

Being able to quickly solve different problem instances of the same stochastic optimization problem can be particularly useful when the system is deployed in a fast-changing environments. Any change to an aspect of the environment, e.g., any change to an estimate for a parameter of the observation distribution or cost function, represents a change to a different problem instance having different parameter values for the parameters defined by the stochastic optimization problem. In some cases, these changes can occur every few minutes or seconds. Thus, it may be impractical or impossible to deploy some existing system that require the system to recompute a solution for each problem instance from scratch, as such existing systems are unable to keep up with the changes to the environment. Using techniques described in this specification, a system can continuously solve new problem instance using a trained neural network without any significant delay, allowing the system to react to environmental changes in real-time or near-real-time.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example stochastic optimization system.

FIG. 2 is a diagram of an example training system.

FIG. 3 illustrates an example value function whose parameters have been generated by a value function neural network.

FIG. 4 is a flow diagram of an example process for solving a multi-stage stochastic optimization problem instance using a trained neural network.

Like reference numbers and designations in the various drawings indicate like elements.

### DETAILED DESCRIPTION

This specification describes a system that uses machine learning to execute multi-stage stochastic optimization.

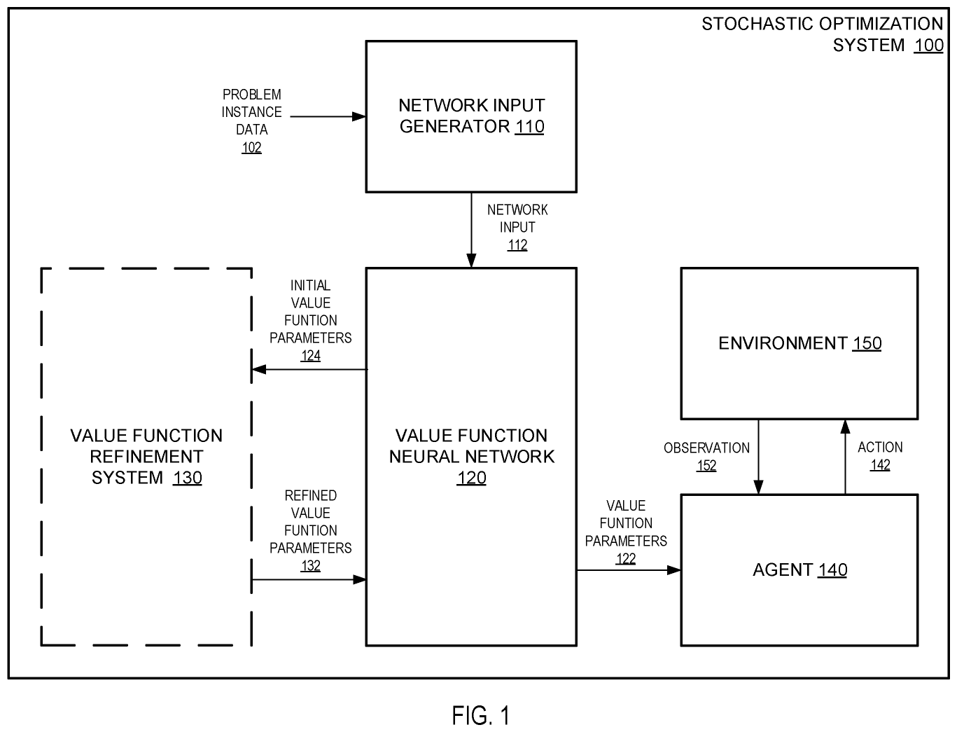

FIG. 1 is a diagram of an example stochastic optimization system 100. The stochastic optimization system 100 is an example of a system implemented as computer programs on one or more computers in one or more locations, in which the systems, components, and techniques described below can be implemented.

The stochastic optimization system 100 is configured to solve problem instances of a particular multi-stage stochastic optimization problem. In particular, the stochastic optimization system 100 is configured to process data 102 characterizing a particular instance of the multi-stage stochastic optimization problem, and to control an agent 140 interacting with an environment 150 corresponding to the particular problem instance across multiple time steps t∈{1, . . . , T}. At each time step t the agent 140 can receive an observation 152 that identifies a current state of the environment 150 and, in response, execute an action 142 in the environment 150. Example multi-stage stochastic optimization problems whose instances can be solved by the stochastic optimization system 100 are described below.

The stochastic optimization system 100 can solve the multi-stage stochastic optimization problem instance defined by the data 102 using a value function neural network 120 that is configured to generate parameters 122 of a value function corresponding to the problem instance defined by the data 102. The value function can represent, given an action 142 taken by the agent 140 at a particular time step, the expected value of the objective function of the problem instance defined by the data 102 subsequent to the particular time step. In some implementations, as described in more detail below, the value function neural network 120 can generate a respective different set of parameters 122 for each time step of the multi-stage stochastic optimization problem instance; that is, the neural network 120 can determine a respective different value function for each time step.

After the value function neural network 120 has generated the value function parameters 122, the agent 140) can directly use the value function defined by the parameters 122 to select actions 142 to interact with the environment 150. In particular, the agent 140 can use the value function to select actions that minimizes expected future costs (or maximizes expected future rewards). For example, given the value function Vₜ(xₜ) corresponding to time step t, the agent 140) can identify the action 142 xₜ that minimizes Vₜ(xₜ), or minimizes the sum of Vₜ(xₜ) and the cost of executing xₜ. In this specification, an action is called an “optimal” action if the action minimizes expected future costs or maximizes expected future rewards, e.g., according to a value function for the problem instance.

As described above, generating the value function parameters 122 using the value function neural network 120 can be significantly more efficient than some other existing techniques for determining value functions, e.g., stochastic dual dynamic programming (SDDP). For example, while executing SDDP can require hundreds or thousands of iterations to approximate a value function for a multi-stage stochastic optimization problem instance, the value function neural network 120 can be a feedforward neural network that is configured to generate the value function parameters 122 in a single forward pass.

The problem instance data 102 can include any appropriate data for defining the particular problem instance that the stochastic optimization system 100 is to solve. For example, the problem instance data 102 can include data describing one or more of (i) an observation distribution, (ii) a cost function, (iii) a feasible action set.

The observation distribution represents a distribution from which the observations 152 can be sampled. In some implementations, the observation distribution is a single distribution P for all time steps t. In some other implementations, the observation distribution includes a respective distribution Pₜ for each time step t. That is, for each time step t, an observation ξₜ 152 can be sampled, ξₜ˜Pₜ(·).

In some implementations, the observations 152 are considered to be independent of previous observations 152 and actions 142 executed by the agent 140; that is, Pₜ can be an independent random variable. In some other implementations, the observations 152 depend on one or more of the previous observations 152 or previous actions 152 executed by the agent 140; that is, the observations 152 can be determined according to a function Pₜ(ξₜ₋₁, ξₜ₋₂, . . . , xₜ₋₁, xₜ₋₂, . . . ). The below description generally refers to the case where the observations 152 are independent, although it is to be understood that the techniques described below can be applied when the observations have one or more dependencies.

The cost function is a function that identifies, given the observation ξₜ drawn for the current time step, a cost (or, equivalently, a reward) for the agent 140. In some implementations, the cost function is a single function c(ξₜ) for all time steps t. In some other implementations, the cost function includes a respective different function cₜ(ξₜ) for each time step t.

The feasible action set identifies, for each time step, a respective set of actions 142 that are available to the agent 140. The feasible action set χₜ at time step t can depend on the action xₜ₋₁ executed at the previous time step t−1 and the observation ξₜ at the current time step t. That is, at each time step t, the agent can execute an action xₜ∈χₜ(xₜ₋₁, ξₜ).

In some implementations, the feasible action sets χₜ can be expressed by:

$${χ}_{t} ( {x}_{t - 1} , {ξ}_{t} ) := \{ {x}_{t} \vert {A}_{t} ( {ξ}_{t} ) {x}_{t} = {b}_{t} ( {ξ}_{t} ) - {B}_{t - 1} ( {ξ}_{t} ) {x}_{t - 1} , {x}_{t} \geq 0 \} , ∀ t = 2 , … , T ,$$

$${χ}_{t} ( {ξ}_{1} ) := \{ {x}_{1} \vert {A}_{1} ( {ξ}_{1} ) {x}_{1} = {b}_{1} ( {ξ}_{1} ) , {x}_{1} \geq 0 \} ,$$

where Aₜ, Bₜ, and bₜ are known functions, e.g., known matrices. For example, Aₜ, Bₜ, and bₜ for each time step t can be provided in the problem instance data 102.

For each time step t, the cost for executing the selected action xₜ can determined to be cₜ(ξₜ)^{T}xₜ. Thus, the goal of the agent 140 is to minimize the expected sum of linear costs

$${\sum }_{t = 1}^{T} {{c}_{t} ( {ξ}_{t} )}^{T} {x}_{t} .$$

The stochastic optimization system 100 includes a network input generator 110 that is configured to process the problem instance data 102 and to generate a network input 112 for the value function neural network. The network input 112 can have any appropriate format.

In some implementations, the network input generator 110 reshapes the problem instance data 102 to generate the network input 112. For example, if the problem instance data 102 includes the Aₜ, Bₜ, and bₜ matrices as described above and the value function neural network 120 is configured to process network inputs 112 that are one-dimensional tensors, then the network input generator 110 can “flatten” the matrices Aₜ, Bₜ, and bₜ to generate the one-dimensional network input 112.

In some other implementations, the network input 112 can be generated heuristically such that the input 112 compactly encodes the problem instance data 102. Generally, the matrices Aₜ, Bₜ, and bₜ can be large and sparse, and so including each element of these matrices in the network input 112 can cause the network input 112 also to be highly sparse (i.e., have a high proportion of zero values), and thus an inefficient encoding of the problem instance defined by the data 102. Training the value function neural network 120 can be difficult using such sparse signals.

Therefore, the network input generator 110 can be configured to generate a lower-dimensional network input 112 that more efficiently encodes the information required by the value function neural network 120 to generate the value function parameters 122. As described above, a stochastic optimization problem defines a set of parameters for a class of stochastic optimization problem instances, where each problem instance identifies a respective parameter value for each parameter defined by the stochastic optimization problem. The network input 112 can thus heuristically encode, for each parameter, the parameter value identified by the problem instance defined by the data 102. The network input 112 can thus be highly dependent on the particular multi-stage stochastic optimization problem whose instances the stochastic optimization system 100 is configured to solve. Example multi-stage stochastic optimization problems are described in more detail below.

In implementations in which the value function neural network 120 is configured to generate parameters 122 of a different respective value function for each time step in the multi-stage stochastic optimization problem instance defined by the data 102, the network input 112 can encode the time step for which the neural network 120 should generate value function parameters 122. For example, the network input 112 can include a positional encoding that identifies the particular time step of the predetermined number of time steps in the multi-stage stochastic optimization problem instance. As a particular example, the positional encoding can be a one-hot vector that includes (i) an element corresponding to the particular time step that has a value of ‘1’ and (ii) a respective element corresponding to each other time step that has a value of ‘0’. The positional encoding can be concatenated to the network input 112 generated from the problem instance data 102.

The network input generator 110 can provide the network input 112 to the value function neural network 120, which can process the network input 112 to generate a network output that includes or represents the value function parameters 122.

Generally, the value function determined by the value function neural network 120 can be represented in any appropriate way. In some implementations, the value function is a piecewise-linear function. That is, if the actions 142 xₜ taken by the agent 140 are n-dimensional, then the value function Vₜ(xₜ), which outputs a single value given the action xx, can be composed of a set of hyperplanes in (n+1)-dimensional space, and can be defined to be, for each xₜ, the minimum (or maximum) height of the set of hyperplanes at xₜ.

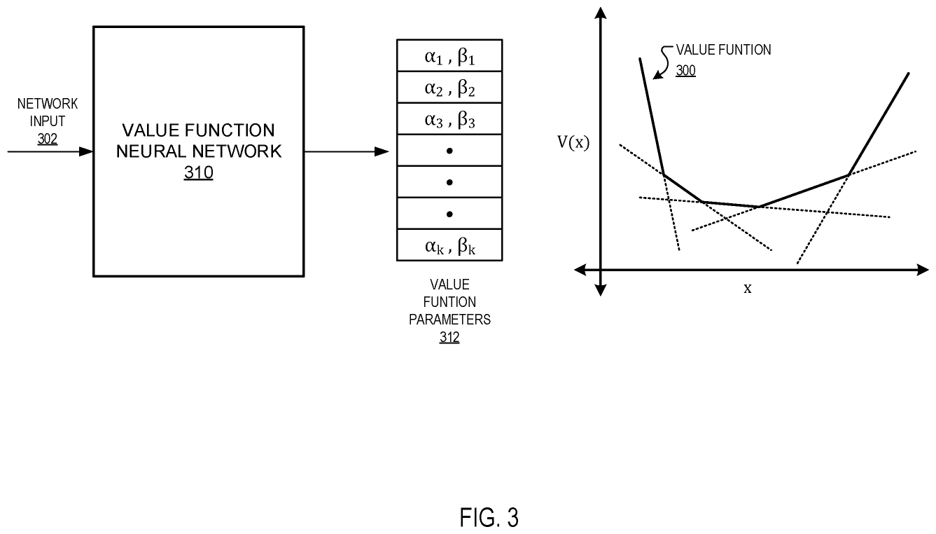

FIG. 3 illustrates an example value function 300 whose parameters have been generated by a value function neural network 310.

The value function neural network 310 is configured to process a network input 302 characterizing a particular problem instance of a multi-stage stochastic optimization problem. For example, the value function neural network 310 can be configured similarly to the value function neural network 120 described with reference to FIG. 1.

The value function neural network 310 has been configured through training to generate a network output that identifies a set of value function parameters 312 that parameterize the value function 300 V(x). In particular, the value function neural network 310 generates a network output that includes, for each of multiple hyperplanes in (n+1)-dimensional space where x is n-dimensional, a set of parameters αⱼ, βⱼ defining the hyperplane. For example, the parameters αⱼ, βⱼ can identify the slope and intercept of the j^{th} hyperplane. As a particular example, the network output can be a one-dimensional tensor that includes each αⱼ, βⱼ pair.

As illustrated on the right side of FIG. 3, the value function 300 is defined to be the maximum height of the set of hyperplanes defined by the value function parameters 312.

In some implementations, the value function neural network is configured to generate a fixed number of hyperplanes. That is, regardless of the network input 302, the value function neural network 310 generates parameters 312 for exactly k hyperplanes. For example, the value function neural network 310 can be a feedforward neural network that is configured to process the network input 302 using one or more feedforward neural network layers and to generate a fixed-size network output.

In some other implementations, the value function neural network is configured to generate a varying number of hyperplanes for each network input 302. That is, depending on the problem instance encoded by the network input 302, the value function neural network 310 can determine the number of hyperplanes in the value function 300. Different problem instances can have value functions with differing topography, so the value function neural network 310 can be configured through training to determine the optimal number of hyperplanes to define the value function for each different problem instance. For instance, value functions with relatively complicated topographies may require more hyperplanes to approximate than value functions with simpler topographies.

For example, the value function neural network 310 can be an autoregressive neural network that is configured to iteratively generate parameters 312 for new hyperplanes until determining to stop. As a particular example, at each of multiple processing steps j the autoregressive value function neural network 310 can generate a new αⱼ, βⱼ pair. When the network 310 generates a special ‘end’ token, the network 310 can determine to stop generating new hyperplanes. In some implementations, the value function neural network 310 is an attention-based neural network, e.g., a Transformer neural network, that applies a self-attention mechanism across previously-generated parameters 312 when generating new parameters 312.

In some implementations, as described above, the network input 302 identifies a particular time step of the multi-stage stochastic optimization problem, and the value function neural network 310 generates a value function 300 that corresponds only to the particular time step.

Referring back to FIG. 1, in some implementations, the value function neural network 120 is configured to generate value function parameters 122 representing a value function in a lower-dimensional space than the problem instance defined by the data 102. That is, if the actions defined by the problem instance data 102 are n-dimensional, then the value function is a surface in (m+1)-dimensional space where m<n. Some problem instances have action spaces that are very high-dimensional, and so the value functions are also high-dimensional; e.g., n can be more than one hundred, more than one thousand, or more than ten thousand. Training a value function neural network 120 to generate very high-dimensional value functions can be infeasible, and so the value function neural network 120 can generate a value function in a lower-dimensional space. In other words, the value function generated by the value function neural network 120 (and parameterized by the value function parameters 122) is an embedding, in a lower-dimensional space, of the “true” value function in the action space of the problem instance.

The value function neural network 120 can also define a relationship between (i) the coordinate space of the value function parameters 122 and (ii) the action space defined by the problem instance data 102, so that the lower-dimensional value function can be used to select actions in the higher-dimensional action space. In particular, the value function neural network 120 can define a transformation (e.g., a linear transformation defined by an m×n matrix) from (i) the coordinate space of the value function parameters 122 to (ii) the action space defined by the problem instance data 102, such that each point in the former space can be projected into the latter space.

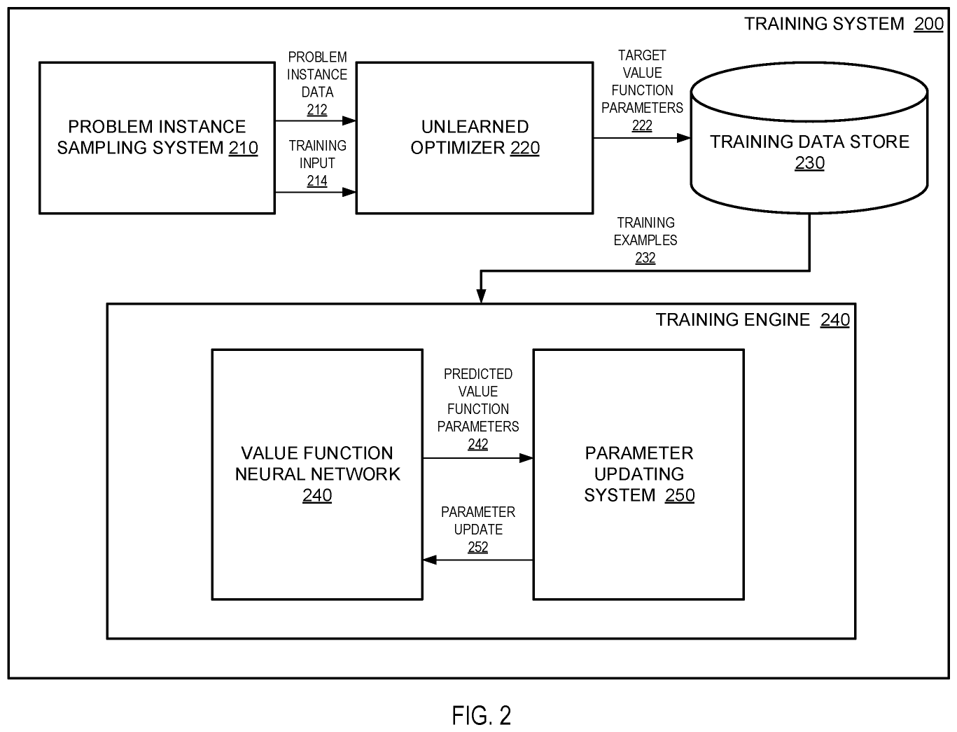

In some such implementations, the lower-dimensional space of the value function (and the transformation to the higher-dimensional action space) is machine-learned and configured specifically for the problem instance defined by the data 102. For example, the projection can be generated from the network output of the value function neural network 120. As a particular example, the network output can include each element of a matrix that defines the transformation. The value function neural network 120 can be configured through training to generate value functions in low-dimensional coordinate spaces that encode maximal information about the corresponding “ground-truth” value functions in the action space of the problem instance. For example, the value function neural network 120 can be configured through training to generate value functions in an (m+1)-dimensional coordinate space that is defined by the m+1 top principal components of a training set of ground-truth value functions in the action space of problem instances of the multi-stage stochastic optimization problem. Example techniques for training the value function neural network 120 are described in more detail below with reference to FIG. 2.

In some other such implementations, the lower-dimensional space of the value function (and the transformation to the higher-dimensional action space) is predetermined, i.e., the same for each problem instance of the multi-stage stochastic optimization problem. For example, the lower-dimensional space can be defined by the top principal components of a data set of ground-truth value functions in the action space of the instances.

In some implementations, the stochastic optimization system 100 includes a value function refinement system 130. The value function refinement system 130 can be configured to obtain an initial set of value function parameters 124 generated by the value function neural network 120 as described above, and to process the initial parameters 124 using an unlearned optimizer to generate a refined set of value function parameters 132.

For example, in implementations in which the initial value function parameters 124 represent a set of hyperplanes, as described above, the value function refinement system 130 can be configured to execute a cutting plane method to refine the value function defined by the initial value function parameters 124, e.g., by adding new hyperplanes to the set of hyperplanes defined by the initial value parameters 124. That is, the refined value function parameters 132 can include (i) all hyperplanes defined by the initial value function parameters 124 and (ii) one or more new hyperplanes generated by executing the cutting plane algorithm. As a particular example, the value function refinement system 130 can execute SDDP to add new hyperplanes to the set. As another particular example, the value function refinement system 130 can execute a progressive hedging algorithm. Although the below description generally refers to executing SDDP, it is to be understood that any appropriate cutting plane algorithm can be executed.

Thus, the hyperplanes defined by the initial value function parameters can be used as a “warm start” to SDDP, significantly improving the efficiency of the SDDP execution. In particular, if the initial value function parameters define k hyperplanes, then using the k hyperplanes as a starting point for SDDP can be equivalent to executing hundreds or thousands of iterations of SDDP. Whereas the SDDP execution often requires many iterations before generating high-quality hyperplanes, the value function neural network 120 can be configured through training to generate an optimal set of hyperplanes that efficiently approximates the value function.

In some implementations in which the initial value function parameters 124 are in a lower-dimensional space than the action space defined by the problem instance data 102, The value function refinement system 130 can continue to add hyperplanes in the lower-dimensional space, thus generating refined value function parameters 132 that are also in the lower-dimensional space. In some other such implementations, the value function refinement system 130 can first project each hyperplane represented by the initial value function parameters 124 into higher-dimensional action space, and then add hyperplanes to the higher-dimensional action space, thus generating refined value function parameters 132 that are also in the higher-dimensional space.

Instead of or in addition to adding additional hyperplanes value function defined by the initial parameters 124, the value function refinement system 130 can refine the value function by performing interpolation between different hyperplanes, smoothing the surface of the value function.

The value function neural network 120 can provide the value function parameters 122 (or, in implementations that include the value function refinement system 130, the refined value function parameters 132) to the agent 140 (or a control system of the agent) for interacting with the environment 150. In particular, at each time step in the multi-stage stochastic optimization problem instance, the agent 140 can select an action that minimizes expected future costs (or maximizes expected future rewards) according to the value function defined by the parameters 122. For example, at each time step t, the agent 140 can select an action that minimizes the sum of (i) the cost of executing the action at the current time step and (ii) the expected future costs after executing the action in the current time step according to the value function defined by the parameters 122. That is, the agent 140 can compute:

$${x}_{t}^{*} = arg min {{c}_{t} ( {ξ}_{t} )}^{T} {x}_{t} + {V}_{t + 1} ( {x}_{t} )$$

$$s . t . {x}_{t} ∈ {χ}_{t} ( {x}_{t - 1} , {ξ}_{t} )$$

where Vₜ₊₁ is the value function corresponding to the subsequent time step.

In implementations in which the value function neural network 120 is configured to generate a different value function Vₜ for each time step t, the value function neural network 120 can process a respective different network input 112 and generate a respective different set of parameters 122 for each time step, and provide each set of value function parameters 122 to the agent 140.

In some implementations in which the value function parameters 122 represent a value function in a lower-dimensional space than the action space of the problem instance, the agent 140 first projects the value function defined by the parameters 122 (e.g., by projecting each hyperplane defined by the parameters 122) into the higher-dimensional action space, and then selects actions 142 directly using the projected value function. In some other such implementations, the agent 140 selects a lower-dimensional action using the lower-dimensional value function, then projects the selected action into the higher-dimensional action space to determine the action 142.

The stochastic optimization system 100 can be configured to solve instances of any appropriate multi-stage stochastic optimization problem.

For example, the multi-stage stochastic problem can be an inventory management problem, where the agent 140 makes decisions for managing an inventory of a product. As a particular example, the agent 140 can receive an observation 152 that identifies one or more of: a demand for the product from one or more customers or sets of customers, a wholesale cost of the product, transportation costs for transporting additional units of the product to the inventory, shipping time for transporting additional units of the product to the inventory, availability of additional units of the product, and so on. The agent 140 can execute an action 142 that includes determining a number of units of the product to maintain in the inventory for the next time step.

As another example, the multi-stage stochastic problem can be a portfolio management problem, where the agent 140 makes decisions for buying and selling assets in a portfolio. As a particular example, the agent can receive an observation 152 that identifies one or more of: a current price of each available asset, a futures price of each available asset, a tax status of each asset, a coupon of one or more assets, a maturity of one or more assets, and so on. The agent can execute an action 142 that includes determining a quantity of each asset to maintain in the portfolio for the next time step.

As another example, the multi-stage stochastic problem can be an energy planning problem, where the agent 140 makes decisions for allocating energy resources across a network. As a particular example, the multi-stage stochastic optimization problem can be optimizing scheduling of a hydrothermal generating system. For instance, at each stage of a planning period, the objective of the multi-stage stochastic optimization problem can be to determine the generation targets for each of one or more hydrothermal plants: that is, the actions xx can identify generation values. The costs cₜ can be defined according to the operation cost of the hydrothermal plants, e.g., the fuel costs and the failure cost in load supply. The observations ξₜ and/or costs cₜ can also be defined according to the limit of stored water in the system reservoirs.

As another example, the multi-stage stochastic problem can be a chemistry problem. As a particular example, the multi-stage stochastic optimization problem can be optimizing waste and biomass valorization, e.g., lignin valorization. For instance, at each stage, the objective of the multi-stage stochastic optimization problem can be to determine the inlet flow rate into a reactor of the valorization process in order to minimize the total expected deviation from predetermined target levels. The constraints on the stochastic optimization problem can include enforcing the variables following the chemical stochastic dynamics and/or restricting the inlet flow in physical feasible sets.

FIG. 2 is a diagram of an example training system 200. The training system 200 is an example of a system implemented as computer programs on one or more computers in one or more locations, in which the systems, components, and techniques described below can be implemented.

The training system 200 is configured to train a value function neural network 240 to generate parameters for value functions corresponding to problem instances of a particular multi-stage stochastic optimization problem. For example, the value function neural network 240 can be configured similarly to the value function neural network 120 described above with reference to FIG. 1.

The training system 200 includes a problem instance sampling system 210, an unlearned optimizer 220, a training data store 230, and a training engine 240.

The problem instance sampling engine is configured to generate training inputs 214 to the value function neural network 240, where each training input represents a respective problem instance of the particular multi-stage stochastic optimization problem.

To generate a training input 214, the problem instance sampling system 210 determines a new problem instance of the particular multi-stage stochastic optimization problem. As described above, the particular multi-stage stochastic optimization problem can identify one or more parameters that describe the stochastic environment, where each problem instance of the particular multi-stage stochastic optimization problem has respective different parameters values for the one or more parameters. In some implementations, the particular multi-stage stochastic optimization problem can further define a distribution of values for each parameter, e.g., by defining a Normal distribution for each parameter. The problem instance sampling system 210 can then sample parameter values for each parameters according to their respective distributions, thus determining a new problem instance. The new problem instance can be represented using problem instance data 212, which can have a similar format to the problem instance data 102 described above with reference to FIG. 1.

The problem instance sampling system 210 can then generate the training input 214 from the problem instance data, e.g., as described above with reference to the network input 112 depicted in FIG. 1.

The unlearned optimizer 220 is configured to execute a stochastic optimization algorithm, e.g., SDDP, to generate a set of target value function parameters 222. The target value function parameters 222 represent the “ground-truth” target output of the value function neural network 240, i.e., the target value function parameters 222 represent the ground-truth value function. The unlearned optimizer 220 can use any appropriate stochastic optimization algorithm that is configured to approximate a value function, e.g., a cutting plane algorithm such as SDDP. In some implementations, the unlearned optimizer 220 defines the ground-truth value function using only the final k cutting planes generated by the cutting plane algorithm out of j total cutting planes generated by the cutting plane algorithm, j k. That is, the unlearned optimizer 220 can allow the cutting plane algorithm to “burn-in” before generating the target value function parameters 222.

Typically the stochastic optimization algorithm used by the unlearned optimizer requires significant time and computing resources to generate the target value function parameters 222, whereas the value function neural network 240, after training, requires significantly less time and computing resources. That is, the training system 200 can train the value function neural network 240 to predict the output of the unlearned optimizer 220 in a significantly more efficient way.

The training data store 230 is configured to store the generated training examples 232, which each include (i) a training input 214 and (ii) the corresponding target value function parameters 222.

The training engine 240) is configured to obtain the training examples 232 and to use the training examples 232 to train the value function neural network 240. The training engine 240) can process the training input 214 of each training example 232 to generate a respective set of predicted value function parameters 242. A parameter updating system 250 can then determine a parameter update 252 to the parameters of the value function neural network 240) according to an error between (i) the predicted value function parameters 242 and (ii) the corresponding target value function parameters 222. The training engine 240) can then apply the parameter update 252 to the parameters of the value function neural network 240, e.g., using backpropagation and stochastic gradient descent.

The parameter updating system 250 can use any appropriate training loss to generate the parameter update 252. For example, the parameter updating system 250 can use any measure of the distance between (i) the predicted value function parameters 242 and (ii) the corresponding target value function parameters 222 to generate the parameter updated, e.g., the Earth Mover's Distance (EMD). In some implementations in which the predicted value function parameters 242 represent a set of hyperplanes, the parameter updating system 250 uses a distance measure that can operate on unordered sets of hyperplanes (e.g., EMD), as the value function neural network 240 does not assign an order to the hyperplanes.

As described above with reference to FIG. 1, in some implementations, the value function neural network is configured to generate predicted value function parameters 242 that represent a value function in a lower-dimensional coordinate space than the action space defined by the problem instance data 212. In some such implementations, the value function neural network 240 can further be configured to automatically determine the lower-dimensional coordinate space itself, e.g., by generating a transformation matrix U that projects points from the lower-dimensional coordinate space top the action space of the problem instance data 212.

As a particular example, the parameter updating system 250 can compute the following loss function;

$$l = {\sum }_{i = 1}^{n} {\sum }_{t = 1}^{T} ( - {( {x}_{t}^{i} )}^{T} {{U}^{i} ( {U}^{i} )}^{T} {x}_{t}^{i} + EMD ( {V}_{t}^{i *} ( \cdot ) , {V}_{t}^{i ′} ( \cdot ) ) ) + λσ ( W )$$

$$s . t . {( {U}^{i} )}^{T} {U}^{i} = I$$

where t={1, . . . , T} represents the times steps of the multi-stage stochastic optimization problem instance, i={1, . . . , n} represents a batch of multiple training examples 232, Uⁱ is the transformation matrix for the i^{th} training example, xₜⁱ is the selected action for training example i at time step t, Vₜⁱ*(·) represents the target value function parameters 222 for training example i, Vₜⁱ′(·) represents the predicted value function parameters for training example i, W is the set of all learned parameters including the parameters of Uⁱ and Vₜⁱ′, σ(W) denotes a regularizer of W, λ is a hyperparameter, and/is the identity matrix. The condition (Uⁱ)^{T}Uⁱ=I enforces the requirement that the Uⁱ represents a transformation to a coordinate space with orthonormal basis vectors. In particular, the above loss function incentivizes learning a U matrix that represents a transformation to a coordinate space whose basis vectors are the principal components of the value functions defined by the target value function parameters 222.

The parameter updating system 250 can determine an update to the transformation matrix U by computing:

$${\tilde{grad}}_{U} l = ( I - LT ( {U}^{T} U ) ) Ξ {U}^{T} = Ξ {U}^{T} - LT ( {U}^{T} U ) Ξ {U}^{T}$$

where LT(·) extracts the lower triangular part of a matrix, setting the upper triangular pat to zero, and Ξ=ΣₜΣᵢ₌₁ⁿxₜⁱ(xₜⁱ)^{T}.

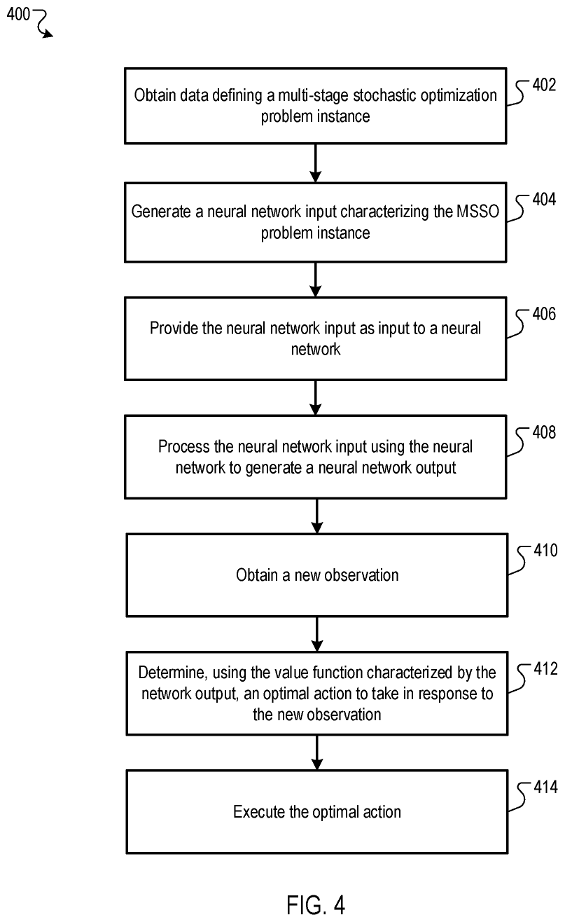

FIG. 4 is a flow diagram of an example process 400 for solving a multi-stage stochastic optimization problem instance using a trained neural network. For convenience, the process 400 will be described as being performed by a system of one or more computers located in one or more locations. For example, a stochastic optimization system, e.g., the stochastic optimization system 100 depicted in FIG. 1, appropriately programmed in accordance with this specification, can perform the process 400.

The system obtains data defining a multi-stage stochastic optimization (MSSO) problem instance (step 402). The data can characterize (i) an observation distribution, (ii) an action space, and (iii) a cost function of the MSSO problem instance. For example, the data can include respective parameter values for each of one or more parameters identified by the MSSO problem corresponding to the problem instance. In some implementations, the data defines different observation distributions, action spaces, and/or cost functions for each time step in the MSSO problem instance.

The system generates a neural network input characterizing the MSSO problem instance from the data defining the MSSO problem instance (step 404). The neural network input can be a reshaped version of the data obtained in step 402, or can be generated heuristically from the data obtained in step 402, e.g., as described above with reference to FIG. 1.

The system provides the neural network input as input to the trained neural network (step 406). The neural network can be configured through training to generate, from the network input, a neural network output characterizing parameters of a value function corresponding to the MSSO problem instance. The value function can receive as input an action and generate an output representing an expected value of future costs if the action were executed at a current time step of the MSSO problem instance.

In some implementations, the value function corresponds only to the current time step, and the neural network can be configured to generate a network output characterizing parameters of respective different value functions for each time step in the MSSO problem instance defined by the data obtained in step 402.

In some implementations, the neural network is configured to generate value functions that receive, as input, actions in a second action space that is lower-dimensional than the action space defined by the data obtained in step 402. In these implementations, the neural network can also identify a transformation from the second action space to the action space defined by the data.

The neural network can be trained using multiple sampled problem instances of the MSSO problem, e.g., as described above with reference to FIG. 2.

The system processes the neural network input using the neural network to generate the neural network output (step 408). For example, the value function can be a piecewise linear function, and the neural network output can identify respective parameters (e.g., slope and intercept parameters) for one or more hyperplanes.

In some implementations, the system can refine the value function characterized by the neural network output, e.g., by executing additional iterations of a stochastic dual dynamic programming (SDDP) solver to update the value function.

The system obtains a new observation determined according to the observation distribution for the MSSO problem instance (step 410). The new observation can correspond to the current time step, e.g., can be sampled from the observation distribution corresponding to the current time step.

The system determines, using the value function characterized by the network output, an optimal action to take in response to the new observation (step 412). For example, the system can select the action, in the action space corresponding to the current time step, that minimizes the sum of (i) the cost of the action when executed in the current time step and (ii) the value function evaluated at the point corresponding to the action.

The system executes the optimal action (step 414).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data; the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine: in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computer-implemented method, comprising:
obtaining data defining a multi-stage stochastic optimization (MSSO) problem instance, wherein the data characterizes (i) an observation distribution, (ii) an action space, and (iii) a cost function of the MSSO problem instance;
generating a neural network input characterizing the MSSO problem instance from the data defining the MSSO problem instance;
providing the neural network input as input to a neural network that generates, from the network input, a neural network output characterizing parameters of a value function corresponding to the MSSO problem instance, wherein the value function receives as input an action and generates an output representing an expected value of future costs if the action were executed at a current time step:
processing the neural network input using the neural network to generate the neural network output;
obtaining a new observation determined according to the observation distribution for the MSSO problem instance;
determining, using the value function characterized by the network output, an optimal action to take in response to the new observation; and
executing the optimal action.

Embodiment 2 is the method of embodiment 1, wherein the value function is piecewise linear and convex, and wherein the neural network output defines parameters of a plurality of hyperplanes that represent the value function.

Embodiment 3 is the method of any one of embodiments 1 or 2, wherein:
the action space of the MSSO problem instance is a first action space,
the value function receives as input actions from a second action space that is lower-dimensional than the first action space, and
determining the optimal action comprises:
   determining an initial optimal action in the second action space using the value function; and
   applying a transformation to the initial optimal action to generate the optimal action in the first action space.

Embodiment 4 is the method of embodiment 3, wherein the second action space has been machine learned to approximate a space defined by a set of principal components of the first action space.

Embodiment 5 is the method of embodiment 4, wherein the transformation is determined from the neural network output of the neural network.

Embodiment 6 is the method of any one of embodiments 1-5, wherein the neural network has been trained by performing operations comprising:
obtaining a plurality of training examples each comprising (i) a training input characterizing a respective different training MSSO problem instance and (ii) an optimized value function corresponding to the training MSSO problem instance;
processing the plurality of training examples using the neural network to generate respective training outputs characterizing parameters of respective predicted value functions; and
updating a plurality of network parameters of the neural network based on an error between (i) the predicted value functions and (ii) the corresponding optimized value functions.

Embodiment 7 is the method of embodiment 6, wherein the error between (i) the predicted value functions and (ii) the corresponding optimized value functions is determined by computing, for each training example, an Earth Mover's Distance between the predicted value function and the optimized value function of the training example.

Embodiment 8 is the method of any one of embodiments 1-7, further comprising executing a plurality of iterations of a stochastic dual dynamic programming (SDDP) solver to update the value function.

Embodiment 9 is the method of any one of embodiments 1-8, wherein the neural network has been configured through training to process neural network inputs characterizing instances of a particular MSSO problem, and wherein the MSSO problem instance is a member of the particular MSSO problem.

Embodiment 10 is the method of embodiment 9, wherein the particular MSSO problem comprises one or more of:
an inventory optimization problem;
an portfolio optimization problem;
an energy planning problem; or
control of a bio-chemical process.

Embodiment 11 is a system comprising: one or more computers and one or more storage devices storing instructions that are operable, when executed by the one or more computers, to cause the one or more computers to perform the method of any one of embodiments 1 to 10.

Embodiment 12 is one or more non-transitory computer storage media encoded with a computer program, the program comprising instructions that are operable, when executed by data processing apparatus, to cause the data processing apparatus to perform the method of any one of embodiments 1 to 10.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method, comprising:
obtaining data defining a multi-stage stochastic optimization (MSSO) problem instance, wherein the data characterizes (i) an observation distribution, (ii) an action space, and (iii) a cost function of the MSSO problem instance;
generating a neural network input characterizing the MSSO problem instance from the data defining the MSSO problem instance;
providing the neural network input as input to a neural network that generates, from the network input, a neural network output characterizing parameters of a value function corresponding to the MSSO problem instance, wherein the value function receives as input an action and generates an output representing an expected value of future costs if the action were executed at a current time step;
processing the neural network input using the neural network to generate the neural network output;
obtaining a new observation determined according to the observation distribution for the MSSO problem instance;
determining, using the value function characterized by the network output, an optimal action to take in response to the new observation; and
executing the optimal action.

2. The method of claim 1, wherein the value function is piecewise linear and convex, and wherein the neural network output defines parameters of a plurality of hyperplanes that represent the value function.

3. The method of claim 1, wherein:
the action space of the MSSO problem instance is a first action space,
the value function receives as input actions from a second action space that is lower-dimensional than the first action space, and
determining the optimal action comprises:
determining an initial optimal action in the second action space using the value function; and
applying a transformation to the initial optimal action to generate the optimal action in the first action space.

4. The method of claim 3, wherein the second action space has been machine learned to approximate a space defined by a set of principal components of the first action space.

5. The method of claim 4, wherein the transformation is determined from the neural network output of the neural network.

6. The method of claim 1, wherein the neural network has been trained by performing operations comprising:
obtaining a plurality of training examples each comprising (i) a training input characterizing a respective different training MSSO problem instance and (ii) an optimized value function corresponding to the training MSSO problem instance;
processing the plurality of training examples using the neural network to generate respective training outputs characterizing parameters of respective predicted value functions; and
updating a plurality of network parameters of the neural network based on an error between (i) the predicted value functions and (ii) the corresponding optimized value functions.

7. The method of claim 6, wherein the error between (i) the predicted value functions and (ii) the corresponding optimized value functions is determined by computing, for each training example, an Earth Mover's Distance between the predicted value function and the optimized value function of the training example.

8. The method of claim 1, further comprising executing a plurality of iterations of a stochastic dual dynamic programming (SDDP) solver to update the value function.

9. The method of claim 1, wherein the neural network has been configured through training to process neural network inputs characterizing instances of a particular MSSO problem, and wherein the MSSO problem instance is a member of the particular MSSO problem.

10. The method of claim 9, wherein the particular MSSO problem comprises one or more of:
an inventory optimization problem;
an portfolio optimization problem;
an energy planning problem; or
control of a bio-chemical process.

11. A system comprising one or more computers and one or more storage devices storing instructions that when executed by the one or more computers cause the one more computers to perform operations comprising:
obtaining data defining a multi-stage stochastic optimization (MSSO) problem instance, wherein the data characterizes (i) an observation distribution, (ii) an action space, and (iii) a cost function of the MSSO problem instance;
generating a neural network input characterizing the MSSO problem instance from the data defining the MSSO problem instance;
providing the neural network input as input to a neural network that generates, from the network input, a neural network output characterizing parameters of a value function corresponding to the MSSO problem instance, wherein the value function receives as input an action and generates an output representing an expected value of future costs if the action were executed at a current time step;
processing the neural network input using the neural network to generate the neural network output;
obtaining a new observation determined according to the observation distribution for the MSSO problem instance;
determining, using the value function characterized by the network output, an optimal action to take in response to the new observation; and
executing the optimal action.

12. One or more non-transitory computer storage media storing instructions that when executed by one or more computers cause the one more computers to perform operations comprising:
obtaining data defining a multi-stage stochastic optimization (MSSO) problem instance, wherein the data characterizes (i) an observation distribution, (ii) an action space, and (iii) a cost function of the MSSO problem instance;
generating a neural network input characterizing the MSSO problem instance from the data defining the MSSO problem instance;
providing the neural network input as input to a neural network that generates, from the network input, a neural network output characterizing parameters of a value function corresponding to the MSSO problem instance, wherein the value function receives as input an action and generates an output representing an expected value of future costs if the action were executed at a current time step;
processing the neural network input using the neural network to generate the neural network output;
obtaining a new observation determined according to the observation distribution for the MSSO problem instance;
determining, using the value function characterized by the network output, an optimal action to take in response to the new observation; and
executing the optimal action.
